(19) United States
(12) Patent Application Publication
(10) Pub. No.: US 2014/0263061 A1
(43) Pub. Date: Sep. 18, 2014

(54) MEMBRANE CONTACTORS AND SYSTEMS FOR MEMBRANE DISTILLATION OR AMMONIA REMOVAL AND RELATED METHODS

(71) Applicant: Celgard, LLC, Charlotte, NC (US)

(72) Inventors: Gareth P. Taylor, Indian Trail, NC (US); Amitava Sengupta, Charlotte, NC (US)

(73) Assignee: Celgard, LLC, Charlotte, NC (US)

(21) Appl. No.: 14/210,660

(22) Filed: Mar. 14, 2014

Related U.S. Application Data
(60) Provisional application No. 61/791,034, filed on Mar. 15, 2013.

(51) Int. Cl. B01D 63/04; C02F 1/44; B01D 61/36

(52) U.S. Cl. CPC B01D 63/04; B01D 61/364; C02F 1/44
USPC 210/640; 210/321.6; 210/321.87; 210/321.89; 210/321.83; 210/321.8; 210/644

(57) ABSTRACT

New, improved, or modified membrane contactors, modules, systems, and/or methods for membrane distillation and/or ammonia removal, and/or methods of manufacture, use, and/or the like. In accordance with at least selected embodiments, particular possibly preferred membrane contactors, modules, systems, and/or methods for membrane distillation and/or ammonia removal, and/or to particular possibly preferred membrane contactors, modules, systems, and/or methods for membrane distillation and/or ammonia removal, involving membrane contactors adapted for membrane distillation, for ammonia removal, or for both membrane distillation and for ammonia removal, as well as for other membrane contactor systems, methods or processes such as degassing, gasifying, separation, filtration, and/or the like.

### CROSS-REFERENCE TO RELATED APPLICATIONS

This application claims priority to and the benefit of co-pending U.S. Provisional Patent Application No. 61/791,034, filed Mar. 15, 2013, which is hereby incorporated by reference herein in its entirety.

### FIELD OF THE INVENTION

The present disclosure or invention relates generally to new, improved, or modified membrane contactors, modules, systems, and/or methods for membrane distillation and/or ammonia removal, and/or methods of manufacture, use, and/or the like. In accordance with at least selected embodiments, the present invention relates to particular possibly preferred membrane contactors, modules, systems, and/or methods for membrane distillation and/or ammonia removal, and/or to particular possibly preferred membrane contactors, cartridges, modules, systems, and/or methods for membrane distillation and/or ammonia removal, involving membrane contactors adapted for membrane distillation, for ammonia removal, or for both membrane distillation and for ammonia removal, as well as other membrane contactor systems, methods or processes such as degassing, gasifying, separation, filtration, and/or the like.

### BACKGROUND OF THE INVENTION

A membrane contactor may be used for many purposes, including, but not limited to, removing entrained gases from liquids, debubbling liquids, filtering liquids, and adding a gas to a liquid. Membrane contactors are known to be used in many different applications; for example, a membrane contactor may be used in membrane distillation and/or ammonia removal. Membrane contactors also may provide a means of accomplishing gas/liquid, and liquid/liquid (which can encompass liquid/dissolved solid) separations. Membrane contactors typically are used to bring two immiscible fluid phases (for example, a first liquid and a second liquid, or a gas and a liquid) into contact with one another to effect separation and/or transfer of one or more components from one fluid to the other.

A hollow fiber membrane contactor typically includes a bundle of microporous hollow fibers and a rigid shell or housing enclosing the fiber bundle. The shell may be provided with four fluid ports: an inlet for introducing the first fluid, an outlet for discharging the first fluid, an inlet for introducing the second fluid, and an outlet for discharging the second fluid. The hollow fibers may be potted, for example, in epoxy or some similar material, on both ends, within the housing, to form polymeric tube sheets with the fiber bores opening on each end into common first and second end cap portions of the shell. In a “tube-side” or “lumen-side” contactor, the first end cap may contain the inlet for the first fluid, which is designated the “tube-side” or “lumen-side” fluid because it is the fluid that passes through the internal lumens of the fibers. The second end cap contains the outlet for discharging the lumen-side fluid. The second fluid, designated the “shell-side” fluid, typically enters and exits the housing through inlet and outlet ports arranged between the tube sheets, whereby the shell-side fluid contacts the external surfaces of the fibers. The shell-side fluid flows through the interstices between fibers of the fiber bundle and may be directed to flow parallel to or perpendicular to the fiber length. As an example, U.S. Pat. No. 5,352,361 to Prasad, et al., incorporated by reference herein in its entirety, may assist in a background understanding of fluid contact across hollow fiber membranes within a shell.

In a “shell-side” contactor, the contactor may include a central core which passes through the end caps and has a first end serving as the inlet for the first fluid, which is designated the “shell-side” fluid because it is the fluid that passes over the exterior or shell of the hollow fibers. The first end cap may contain the inlet for the second fluid, which is designated the “tube-side” or “lumen-side” fluid because it is the fluid that passes through the internal lumens of the fibers. The second end cap contains the outlet for discharging the lumen-side fluid. The first fluid, designated the “shell-side” fluid, typically enters and exits the housing through inlet and outlet ports (open ends) of the perforated core, and typically exits and re-enters the perforations in the core between the tube sheets whereby the shell-side fluid contacts the external surfaces of the fibers. The shell-side fluid flows through the interstices between fibers of the fiber bundle and may be directed to flow parallel to or perpendicular to the fiber length. Because the tube sheets separate the lumen-side fluid from the shell-side fluid, the lumen-side fluid does not mix with the shell-side fluid, and the only transfer between the lumen-side fluid and the shell-side fluid occurs through the walls of the hollow fibers. The fine pores in the fiber wall are normally filled with a stationary layer of one of the two fluids, the other fluid being excluded from the pores due to surface tension and/or pressure differential effects. Mass transfer and separation are usually caused by diffusion, which is typically driven by the difference in concentration of the transferring species between the two phases. Typically, no convective or bulk flow occurs across the membrane. In the case of gas/liquid separations, membrane contactors are typically fabricated with hydrophobic hollow fiber microporous membranes. Since the membranes are hydrophobic and have very small pores, liquid will not easily pass through the pores. As such, the membranes may act as an inert support that brings the liquid and gas phases into direct contact, without dispersion. The mass transfer between the two phases may be governed by the difference in partial pressure of the gas species being transferred. For liquid systems, the liquid/liquid interface at each pore is typically immobilized by the appropriate selection of membrane and liquid phase pressures. In this case, the membrane also may act as an inert support to facilitate direct contacting of two immiscible phases without mixing.

A new or improved liquid degassing membrane contactor or module was disclosed in U.S. Patent Publication No. 2012-0247337-A1 (application Ser. No. 13/247,213, now U.S. Pat. No. 8,449,659), which is incorporated herein by reference in its entirety, that allows for relatively small, modular, degassing modules. The modules disclosed in the 2012-0247337 publication may be used, for example, in industrial processes, at power plants, on offshore oil rigs or drilling platforms, to replace or augment vacuum towers, to provide the benefits of modularity and replaceable cartridges, reduce cost, reduce complexity, eliminate bolts or v-band clamps, and/or the like.

Membrane distillation, or osmotic distillation, is a separation process in which a liquid mixture containing a volatile component is contacted with a microporous, non-liquid-wettable membrane whose opposite surface is exposed to a second liquid phase capable of absorbing that volatile component. Membrane distillation may be used for many purposes, including, but not limited to, desalination, the concentration of beverages and other liquid foodstuffs, the concentration of aqueous solutions of thermally labile pharmaceutical products and biologicals, and/or the like. The primary advantages of membrane distillation may lie in the ability to concentrate solutes to very high levels at low temperature and pressure, with minimal thermal or mechanical damage to or loss of those solutes. The membrane distillation process also may enable the selective removal of a single volatile solute from an aqueous solution (for instance, ethanol from wine and other ferments) using water as the extracting solvent. Low-alcohol-content beverages can be produced in this manner with minimal losses of volatile flavor and fragrance components. Osmotic distillation (OD) may be an attractive complement or alternative to other athermal or low temperature separation techniques such as ultrafiltration (UF), reverse osmosis (RO), pervaporation, and/or vacuum freeze drying.

Ammonia is a prevalent problem in the wastewater of many industries. Because ammonia is widely used as a cleaning agent in many processes (by way of example only, the production of semiconductors or components to be used in the electronics industry), it may end up in plant wastewater and must be treated or removed from water prior to the water being discharged back into the environment. In various emerging markets around the globe, new environmental controls and/or regulations may come into being, which increases the need for effective and affordable systems for ammonia removal from fluids used in industrial processes. Membrane contactors may offer a desirable alternative for removing ammonia from wastewater in many industries, and some membrane contactors can remove up to 90%, even 95%, or more of the incoming ammonia. In addition, membrane contactors may extract ammonia from wastewater and convert it into a harmless ammonium salt, which may have some commercial value as a fertilizer. Ammonia removal systems may vary based on process parameters, and a given ammonia removal system may be sized based on the parameters of the desired application. Desirable process parameters for ammonia removal with membrane contactors may include, but are not limited to: NH₃ inlet concentration >about 500 ppm; pre-filtration (filtering out materials before the ammonia removal process begins) of filtering out materials greater than about 10 μm, or greater than about 5 μm, in diameter; temperature of about 40-55° C.; feed stream pH>about 10; acid stream pH<about 2; and sulfuric acid as stripping media (about 96% by weight), as well as other like parameters, and combinations thereof.

Therefore, a need exists to develop new, improved, or modified contactors, modules, systems, and/or methods for membrane distillation and/or ammonia removal.

### SUMMARY OF THE INVENTION

In accordance with at least certain embodiments, aspects or objects, the present invention addresses the above needs and provides such new, improved, or modified contactors, modules, systems, and/or methods for membrane distillation and/or ammonia removal.

The instant invention is directed toward various membrane contactors, modules, and/or systems, and their methods of manufacture and use. In at least selected embodiments, the present invention is directed to one or more membrane contactors, and/or a system, module or array of membrane contactors useful in the removal of ammonia from a fluid and/or in membrane distillation or osmotic distillation of a fluid. In accordance with at least selected embodiments, examples, or aspects, the present invention is directed to membrane distillation or osmotic distillation with the use of a particular possibly preferred membrane contactor or array of membrane contactor. In accordance with at least selected embodiments, examples, or aspects, the present invention is directed to ammonia removal with the use of a particular possibly preferred membrane contactor or array of membrane contactor.

In accordance with at least certain embodiments, the present disclosure or invention is directed to new, improved, or modified membrane contactors, modules, systems, and/or methods for membrane distillation and/or ammonia removal, and/or methods of manufacture, use, and/or the like. In accordance with at least selected embodiments, the present invention relates to particular possibly preferred membrane contactors, modules, systems, and/or methods for membrane distillation and/or ammonia removal, and/or to particular possibly preferred membrane contactors, cartridges, modules, systems, and/or methods for membrane distillation and/or ammonia removal, involving membrane contactors adapted for membrane distillation, for ammonia removal, or for both membrane distillation and ammonia removal, as well as to other membrane contactor systems, methods or processes such as degassing, gasifying, separation, filtration, and/or the like. In accordance with at least one particular embodiment, the same particular membrane contactor may be used for membrane distillation and for ammonia removal, and is adapted to operate in both membrane distillation and ammonia removal arrays, systems, methods or processes.

### DETAILED DESCRIPTION OF THE DRAWINGS

For the purpose of illustrating the embodiments, examples or aspects of the invention, there is shown in the drawings a form that is presently possibly preferred; it being understood, however, that the present invention is not limited to the precise embodiments, aspects, arrangements, and/or instrumentalities shown.

FIG. 1 is a schematic longitudinal cross-sectional illustration of an exemplary module or contactor of at least one embodiment of the instant invention;

FIG. 2 is an enlarged partial schematic longitudinal cross-sectional illustration of the module or contactor of FIG. 1;

FIG. 3 is a perspective view illustration of the module or contactor of FIG. 1;

FIG. 4 is a side view illustration of the module or contactor of FIGS. 1 and 3;

FIG. 5 is an end view of the module or contactor of FIGS. 1 and 3;

FIG. 6 is a schematic longitudinal cross-sectional illustration of an exemplary potted precursor or intermediate during a first phase of production in accordance with an exemplary production process of at least one embodiment of the instant invention;

FIG. 7 is a schematic longitudinal cross-sectional illustration of an exemplary machined precursor or intermediate during a second phase of production in accordance with the exemplary production process of FIG. 6;

FIG. 8 is a schematic longitudinal cross-sectional illustration of the exemplary module housing or shell of FIGS. 1 and 3 in accordance with at least one embodiment of the instant invention;

FIG. 9 is an end view of the housing of FIG. 8;

FIG. 10 is a schematic perspective view illustration of the exemplary nozzle or liquid port component of FIGS. 1 and 3 in accordance with at least one embodiment of the instant invention;

FIGS. 11, 12 and 13 are respective side, cross section and end views of the nozzle of FIG. 10, and FIG. 12 is a cross section of the nozzle of FIG. 13 taken along line A-A in FIG. 13;

FIGS. 14 and 15 are respective cross section and end views of the potted precursor of FIG. 6, and FIG. 14 is a cross section of the potted precursor of FIG. 15 taken along line B-B in FIG. 15;

FIGS. 16, 17 and 18 are respective perspective, cross section and partial enlarged views of the machined precursor of FIG. 7, and FIG. 18 is an enlarged view of the portion of the housing indicated by line C in FIG. 17;

FIGS. 19 and 20 are respective cross-sectional and end view illustrations of the exemplary end cap or plate of FIGS. 1 and 3 in accordance with at least one embodiment of the present invention, and FIG. 19 is a cross section of the end cap of FIG. 20 taken along line D-D in FIG. 20;

FIGS. 21 and 22 are respective side and end views of one half of at least one embodiment of the exemplary two piece center tube of FIGS. 1 and 6;

FIGS. 23 and 24 are respective side and end views of at least one embodiment of the exemplary assembled two piece center tube of FIGS. 1 and 6;

FIGS. 25 and 26 are respective side and end views of the exemplary solid center tube connector adapted to join two center tube sections as shown in FIGS. 1 and 23;

FIGS. 27A to 27D are respective schematic cross-sectional view illustrations of an exemplary process and equipment for inserting the end cap retaining ring in the housing of at least one embodiment of the instant invention;

FIGS. 28A to 28D are respective schematic cross-sectional view illustrations of an exemplary process and equipment for placing the retaining clip on the nozzle of at least one embodiment of the instant invention;

FIG. 29 is a schematic enlarged cross section illustration of gas transfer across a portion of a hollow fiber membrane;

FIGS. 30, 31 and 32 are schematic illustrations of use of modules in respective exemplary Sweep Gas Mode, Vacuum Mode, and Combo Mode;

FIGS. 33 and 34 are schematic illustrations of respective exemplary parallel and series contactor configurations;

FIGS. 35 and 36 are respective schematic partial perspective view illustrations of selected exemplary liquid and gas (or liquid) port configurations of respective exemplary side and end gas (or liquid) port embodiments in accordance with the present invention;

FIG. 37 is a schematic highly magnified surface view of an example of a hollow fiber membrane array;

FIG. 38 is a schematic perspective end view of a hollow fiber membrane like one from FIG. 37;

FIG. 39 is a schematic enlarged surface view of a portion of the exterior (shell side) of the hollow fiber of FIG. 38;

FIG. 40 is a schematic illustration of a particular exemplary multiple contactor configuration or contactor array in accordance with at least one embodiment of the present invention;

FIGS. 41 and 42 are schematic exemplary data sheets of one particular example of a module or contactor of at least one embodiment of the instant invention;

FIGS. 43 and 44 are schematic illustrations of use of modules in respective exemplary counter-current and co-current modes in accordance with at least exemplary embodiments of the present invention; and

FIG. 45 is a schematic illustration of a particular exemplary multiple contactor configuration or contactor array in accordance with at least one embodiment of the present invention.

### DETAILED DESCRIPTION OF THE INVENTION

In accordance with at least selected embodiments, aspects or objects of the present invention, a possibly preferred membrane contactor for membrane distillation and/or ammonia removal may include at least one integrally potted hollow fiber membrane structure in a cylindrical housing with the ends of the membrane structure recessed in the housing a certain distance, by way of example only, a recess of at least 1″ from each end. The membrane contactor for membrane distillation and/or ammonia removal may also have respective disc, domed and/or other molded shaped end caps adapted to be received in each open end of the housing. In other embodiments, the membrane structure may be recessed in the housing a recess of, for example, at least 2″ from each end. The end caps each may have at least one of liquid and gas ports therein, and the end caps may be adapted to be held in place in the cylindrical housing by at least one retaining element. Such a retaining element may include, for example, a retaining or locking ring received in a groove in the interior of the cylindrical housing. The end caps each may have a central opening therein adapted to receive a liquid end port or nozzle, and another opening therein adapted to receive a gas (or a second liquid) end port or pipe. The integrally potted membrane structure may include a perforated core, a plurality of hollow fiber membranes, and a tube sheet or potting affixing each end of the hollow fibers and adhering to the interior of the housing. The integrally potted membrane structure may be potted in place in the housing by an inverted potting process involving the use of a removable plunger or plug and trimming the ends of the potting and opening the ends of the hollow fibers using a cutting means to produce recessed tube sheets. The length of pipe of the cylindrical housing may be formed of a modified section of pipe including in each end a larger diameter section for receiving an end cap, a groove for receiving a retaining ring, and a flared entrance for facilitating the insertion of the end cap and retaining ring. The length of pipe may be selected from standard PVC, ABS, polypropylene, steel, stainless steel, or other pipe material that will bond with epoxy to facilitate integral potting. Although integral potting may be preferred, one or more cartridges in a shell or housing may be used in a less preferred embodiment.

The above embodiment of a membrane contactor for membrane distillation and/or ammonia removal, or multiple membrane contactors, contactor array or system, may be used for membrane distillation. The above embodiment of a membrane contactor for membrane distillation and/or ammonia removal, or multiple membrane contactors, contactor array or system, may also be used for ammonia removal.

The instant invention of utilizing one or more membrane contactors for ammonia removal and/or membrane distillation may offer several advantages over other designs. Such advantages may include but are not limited to:
Integral potting—This prevents the cartridge from shifting due to lumen side flow. With cartridge-type designs, the pressure differential on the lumen side tends to shift the cartridge downstream. It also tends to compress or accordion the cartridge due to the pressure areas on both ends of the tube sheets. The integral potting of certain membrane contactors described herein provides those contactors with improved or added longitudinal strength. Thus, the contactors, systems, and methods discussed herein provide solutions to construction limitations that may have existed before.
High lumen side pressure capacity
Relatively short fiber lengths—Various membrane contactors described herein may have shorter lengths of fibers in the contactors. For example, in some embodiments, a membrane contactor may have about 20 inches of lumen flow distance. Because heat may be lost through both conduction and vapor transport in a membrane distillation process, it may be important to try to minimize the amount of loss due to conduction. Heat lost to conduction causes the distillation driving force to reduce, potentially resulting in lower distillate product. By having relatively short fiber lengths this phenomenon may be reduced, for example, when compared to distillation using contactors with longer lumen flow distance.
Good temperature capability
Low cost−Membrane contactors and modules as described herein may provide a user with a lower-cost solution for effecting ammonia removal and/or membrane distillation as compared with existing solutions. Lower cost may be important in various applications, for example, the removal of ammonia from the wastewater from various industrial processes (e.g., manufacturing processes), desalination applications, and so forth.
Ability to change fiber variant—When effecting ammonia removal and/or membrane distillation solutions using a membrane contactor or module, there is not one particular “best” fiber to use in such applications. Thus, the contactors, modules, systems, and methods described herein provide for the opportunity for the membrane structures to be made with any number of fiber types.
Cross-flow design—The designs of the membrane contactors and modules described herein are well suited to efficient mass transfer using membrane distillation and/or ammonia removal.
Acid resistance—The materials used in the construction of the various membrane contactors and modules described herein (materials that include, but are not limited to, PP, ABS, PVC, Noryl™, and the like) may provide the membrane contactors and/or modules with desirable resistance to the acid(s) used for ammonia removal and/or other chemicals. By way of example, constructing one or more end caps of the membrane contactor or module using a Noryl™ resin may provide the contactor or module with improved resistance to acids or other chemicals. Noryl™ resins are commercially available from SABIC, and are described to include a family of modified polyphenylene ether resins that include amorphous blends of polyphenylene ether resin and polystyrene. These Noryl™ resins are further described in that they may combine the inherent benefits of polyphenylene ether resin (affordable high heat resistance, good electrical properties, excellent hydrolytic stability, etc.), with excellent dimensional stability, good processability and low specific gravity. In some embodiments herein, one or more reinforced Noryl™ resins may be used, while in other embodiments, non-reinforced Noryl™ resins may be used.

In other embodiments, one or more end caps of the membrane contactor (or any part of the membrane contactor that may be wetted, for example, with an acid-containing solution in an ammonia removal process) may be made from a fluoropolymer resin such as PTFE, to impart chemical resistance to the part(s). One example of a PTFE resin may be Teflon®, which is commercially available from DuPont. In other embodiments, one or more end caps (or other parts of the membrane contactor that may be wetted) may be made from silicone. In ammonia removal applications, such materials may be chosen to ensure, for example, chemical resistance or acid resistance for the part(s). This means that the membrane contactors, systems, and methods disclosed herein may overcome certain material limitations that may have existed for prior contactors, systems, or methods.

Referring to the drawings wherein like numerals indicate like elements, there is shown, in FIG. 1, one embodiment of a module or contactor 100, such as a liquid degassing membrane contactor or a membrane contactor useful in an ammonia removal process or a membrane (or osmotic) distillation process, of at least one embodiment of the present invention. Module 100 includes a cylindrical housing or vessel 110, central end ports or nozzles 112, 114, end caps 116, 118, end cap locks 120, 122, and end ports or openings 124, 126 (such as 1″ NPT openings adapted to receive a threaded end of a 1″ pipe). The module may be adapted for liquid degassing or for ammonia removal or for membrane distillation. For liquid degassing, the end ports or nozzles 112, 114 are liquid ports adapted to preferably respectively receive liquid to be degassed, debubbled, or the like or to discharge degassed or debubbled liquid depending on the direction of liquid flow through the device 100. For ammonia removal, such an end port or nozzle 112 and 114 may be a liquid port adapted to receive a liquid (either liquid containing ammonia or acid solution). End ports or openings 124, 126 are gas ports (or liquid ports) adapted to preferably respectively receive, discharge, remove, or be connected to at least one of a sweep gas, strip gas, vacuum (to be connected to a vacuum source or pump), stream of liquid, or the like (see for example, FIGS. 30 to 32) to facilitate removal or control of the entrained or dissolved gas or gases, or to facilitate ammonia removal or membrane distillation.

Although it may be less preferred than the above, the module 100 may be adapted for adding one or more gases to the liquid, and the central end ports or nozzles 112, 114 may respectively be liquid ports to receive liquid to be treated or modified or to discharge the treated liquid, and ports or openings 124, 126 may be gas ports (or liquid ports) to respectively receive or remove carbon dioxide, nitrogen, and/or the like, to be connected to a gas source or pump, or the like, to facilitate the control or addition of a gas or gases.

Although it may be still less preferred than above, the module 100 may be adapted for controlling or adding humidity to a gas or air stream, and the end ports or nozzles 112, 114 may be liquid ports to receive water, and end ports or openings 124, 126 may be gas ports to respectively receive and remove sweep gas, strip gas, air, or the like, and/or for one or both to be connected to vacuum (to be connected to a vacuum source or pump) to facilitate the creation, addition, removal, and/or control of water vapor, humidity, or the like.

Although it may be yet less preferred than above, the end ports or nozzles 112, 114 may be gas ports, and end ports or openings 124, 126 may be liquid ports or gas ports.

The end ports 112, 114 may be liquid ports, and end ports 124, 126 may be liquid ports, or the end ports 112, 114 may be gas ports, and end ports 124, 126 may also be gas ports.

For at least certain applications, the arrangement may be a countercurrent flow of liquid and/or gas (possibly preferably countercurrent flow liquid 1 and liquid 2). For example, liquid may flow from port 112 to port 114 while gas (or a second liquid) flows from port 126 to port 124, or liquid may flow from port 114 to port 112 while gas (or a second liquid) flows from port 124 to port 126. For at least certain other applications, the preferred arrangement may be a common direction (co-current) flow of liquid and gas (or liquid 1 and liquid 2). For example, liquid may flow from port 112 to port 114 while gas (or a second liquid) flows from port 124 to port 126, or liquid may flow from port 114 to port 112 while gas (or a second liquid) flows from port 126 to port 124. For at least certain still other applications, the preferred arrangement may be flow of liquid from one liquid port to the other while gas is drawn out of both gas ports. For example, both gas ports 124 and 126 may be connected to vacuum (such as to a vacuum pump). For at least certain yet other applications, the preferred arrangement may be flow of liquid from one liquid port to the other while gas is forced into both gas ports. For example, both gas ports 124 and 126 may be connected to a source or supply of gas to be introduced into the liquid (such as for carbonation, nitrogenation, or the like).

Many industries have the need to remove, add or control dissolved gasses in liquids. Module or contactor 100 and similar membrane contactors as shown and described herein can be used in such industries where gasses need to be removed, controlled or added. In other words, there are many membrane degassing and gas transfer applications where the present liquid degasifiers could be used. Furthermore, many industries have the need to remove ammonia from various liquids, and many industries have the need to effect membrane distillation or osmotic distillation.

With reference to FIGS. 1 to 6, module 100 may include a membrane structure, element or unit 130 preferably including a central portion 132 of cylindrical shell, casing or housing 110, with an interior surface 134 (see FIGS. 8 and 9). Further, membrane structure 130 includes potting 138, 140 for sealing the ends of the structure 130 between the casing interior 134 and a center tube 154, for securing the ends of the hollow fibers, and for forming tube sheets. Potting 138, 140 has respective central end openings 142, 144 preferably defined by the interior of the center tube 154.

As shown in FIGS. 1, 2, and 10 to 13, module 100 preferably includes nozzles 112 and 114 including respective first ends 146, 148 adapted to mate with or fit in center tube openings 142, 144, a raised portion 150, and a second end 152 adapted to be received in opening 136 in end cap 118 and to mate with or receive a liquid source or supply such as a standard fitting or flange 153 (for example a 2″ standard coupling such as shown in FIG. 1). Also, nozzles 112 and 114 may have, for example, 1″ NPT openings to receive threaded ends of 1″ pipes.

As shown in FIGS. 1, 2 and 6, membrane structure 130 also preferably includes the center tube 154, baffle 155 and membrane mat 156. Although at least one baffle may be preferred, the contactor or cartridge may be constructed without a baffle. At least two baffles may be used in longer contactors or cartridges. Also, although end ports may be preferred end and/or side ports may be used.

FIG. 1 shows exemplary module or contactor 100 to be a 4 port module having two central end or shell side ports or nozzles 112, 114 and two other end or lumen side ports or openings 124, 126. In accordance with a possibly most preferred embodiment, the housing or shell 110 is preferably a length or section of a standard pipe such as, for example, a 24″ length of an 8″ nominal diameter Schedule 80 PVC pipe, which is preferably modified or machined on each end to receive and retain therein an end cap 116, 118. For oil rig or off shore drilling platform degassing applications, it is preferred to use a non-metallic, corrosion resistant housing 110. Acid resistance and chemical resistance are particularly important in ammonia removal applications as well, as an acid solution is used to remove the ammonia from the liquid containing the ammonia.

FIGS. 3, 4 and 5 show the module 100 of FIG. 1.

Preferably, housing or shell 110 of module 100 has an elongated constant diameter central opening portion 132 and enlarged diameter end portions 162, 164 (see FIGS. 1, 2, 7, and 16 to 19), flared ends 166, 168, and ring retaining grooves 170, 172. In accordance with at least one embodiment, the end caps 116, 118 are sealed in the openings 162, 164 by, for example, respective o-rings in grooves 119 in the end caps. Flared end openings 166, 168 are adapted to receive end caps 116, 118 and end cap locks or rings 120, 122 which fit in grooves 170, 172 to secure the end caps in position in the housing 110 with the end ports 112, 114 in position and being received by respective ends 142,144 of center tube 154. The raised portion 150 and a shoulder 180 of nozzles 112, 114 limit the maximum that the respective ends 146, 148 can be inserted in the respective center tube openings 142, 144. Nozzle ends 146, 148 preferably also include, for example, o-ring grooves 182, 184 for receiving respective o-rings which form fluid tight seals with the ends of the center tube 154.

Further, nozzles 112, 114 are locked in position in the openings 136 in end caps 116, 118 by retaining or locking rings or clips 186, 188 received in respective grooves 187 in nozzles 112, 114.

As described above, the preferred module 100 has a very simple yet very effective construction. The shell side fluid or liquid is separated from the lumen side fluid or gas (except at the membrane interface). Preferably, standard materials and parts are used where possible. For example, standard o-rings and locking rings are used together with custom or modified parts such as the housing, end caps, nozzles, and center tubes. Depending on the module end use or application, different end ports, nozzles, side ports, and/or openings may need to be used.

In certain embodiments, one or more o-rings may be made from an elastomer or a rubber. For example, one or more o-rings may be made from EPDM rubber (ethylene propylene diene monomer rubber). In other embodiments, one or more o-rings may be made from a fluoroelastomer, such as a Viton® fluoroelastomer resin commercially available from DuPont. Such a fluoroelastomer may be used, for example, in applications for ammonia removal where chemical resistance is needed.

Although the center tube 154 may be a single piece perforated pipe (with or without a center plug or flow restrictor), as shown in FIGS. 1, 6, 7, and 21 to 26, it is preferred that center tube 154 be made of at least three parts: a first perforated tube portion 190, a second perforated tube portion 192, and a solid tube connector 194. As shown, the tube connector 194 preferably has respective threaded ends 191 and 193 adapted to mate with internal threads in the ends of tubes 190 and 192 adjacent the connector 194. Also, tube connector 194 preferably has a raised central grooved portion 195 for spacing the tubes 190, 192 and for aiding in forming baffle 155 from, for example, epoxy, as the membrane mat or fabric is wrapped around tube 154, and to help the baffle 155 stay in position after being formed. Similarly, each of tubes 190, 192 may preferably include ribs or grooves 202 near the end opposite connector 194 for aiding in forming potting 138, 140 from, for example, epoxy, after the membrane mat or fabric is wrapped around tube 154 and placed in casing 132, and to help the potting 138, 140 stay in position after being formed. Preferably, each of the tubes 190, 192 has a smooth perforation free inner surface in the end adapted to receive respective ends 146, 148 of nozzles 112, 114.

Membrane mat 156 is preferably separated into two membrane portions 196 and 198 by baffle 155. For example, if liquid to be degassed (or a first liquid) is flowing through module 100 from end port 112 to end port 114, the liquid flows through the opening 113 in end port 112, through opening 142 in tube 190, out through perforations or openings 200 in tube 190, around, for example, the hollow fibers in membrane mat portion 196, over baffle 155 (between baffle 155 and casing interior 134), around, for example, the hollow fibers in membrane mat portion 198, through perforations or openings 200 in tube 192, through opening 144 in tube 192, and out through the opening 115 in nozzle 114. In this example, tube 190 is a liquid distribution tube and tube 192 is a liquid collection tube.

In another example, the liquid to be degassed (or some first liquid) is flowing through module 100 from end port 114 to end port 112, the liquid flows through opening 115 in end port 114, through opening 144 in tube 192, out through perforations or openings 200 in tube 192, around, for example, the hollow fibers in membrane mat portion 198, over baffle 155 (between baffle 155 and casing interior 134), around, for example, the hollow fibers in membrane mat portion 196, through perforations or openings 200 in tube 190, through opening 142 in tube 190, and out through opening 113 in end port 112. In this example, tube 192 is a liquid distribution tube and tube 190 is a liquid collection tube.

Although FIGS. 1, 6 and 7 show a single integrally potted membrane unit or structure in housing 110 of module 100, with a single baffle therein, it is contemplated that two or more such units, two or more baffles, other baffle configurations, no baffle, and/or the like may be used.

Although it is preferred to use one membrane unit having baffled membrane mats therein, it is understood that non-baffled or multiple baffle configurations could be used. For example, membrane mats of short modules may be non-baffled, while those of long modules may include two or more baffles.

With reference to FIGS. 27A-27D, there is schematically represented an exemplary press type process 300 for placing the retaining ring 120 or 122 in the respective groove 170 or 172 in housing 110 to lock the respective end cap 116 or 118 therein. As shown, a plunger 302 is used to press the ring 122 through flared opening 168 and into groove 172. The flared opening 168 helps to compress the ring 122 until it reaches groove 172 and can expand outwardly and lock in groove 172. The same process can be used for ring 120. Such retaining rings may typically be removed with a flat blade screwdriver if needed.

With reference to FIGS. 28A-28D, there is schematically represented an exemplary press type process 400 for placing the retaining ring 186 or 188 in the respective groove 187 in nozzle 112 or 114 to lock the respective nozzle and end cap 116 or 118 in position. As shown, a plunger 402 is used along with an adapter or installation cone 404 placed over the nozzle 114 to press the ring 188 over the conical upper portion 406 of cone 404 to spread the ring, push it down the side of adapter 404 and release it over and into groove 187 in nozzle 114. The conical portion 406 helps to expand the ring 188 so it fits over and down nozzle 114 until it reaches groove 187 and can contract inwardly and lock in groove 187. The same process can be used for ring 186. Such retaining rings may typically be removed with a flat blade screwdriver if needed.

It is contemplated that press type processes 300 and 400 can be combined to simultaneously place rings 122 and 188 in position. Such can be accomplished by using adapter 404 and combining plunger 402 with plunger 302. The same combined process can be used for rings 120 and 186 and may be accomplished with an Arbor Press.

With reference to FIGS. 1 to 5, it is noted that the contactors or modules 100 are preferably self contained membrane contactors, of a reasonable size and weight to be shipped, handled, installed, and replaced. Such contactors may make it easy to construct and to maintain systems or arrays of such modules. In accordance with a possibly preferred example, 8″ nominal diameter contactors are 40″ or less in length, and 16″ diameter contactors are 20″ or less in length.

With reference to FIGS. 1, 2 and 12, the nozzles or ports 112, 114 each have a center opening 113, 115 providing for fluid flow there through.

With reference to FIG. 29, preferably for degassing a liquid such as water, the hollow fibers are hydrophobic microporous membranes having pores which block the passage of liquid but allow passage or transfer of gases and vapors.

FIGS. 30, 31 and 32 illustrate various uses or modes of modules or contactors (Sweep Gas, Vacuum, and both).

FIGS. 33 and 34 show respective parallel and series contactor configurations.

FIG. 35 shows a side gas (or liquid) port configuration module 600 with a side gas (or liquid) port arrangement of at least one embodiment of the instant invention. The module 600 has a housing 610, an end cap 612, an end cap lock 614, an end port 616, and a side port 618.

FIG. 36 shows a preferred end gas (or liquid) port module 700 with an end gas (or liquid) port arrangement of at least one embodiment of the instant invention. The module 700 has a housing 710, an end cap 712, an end cap lock 714, an end port 716, and an end gas (or liquid) port 718.

As schematically shown in FIG. 37, the preferred hollow fiber membrane array 940 includes a plurality of hollow fibers 942, for example, Celgard® X-40 hollow fibers (or X-50 hollow fibers), connected by cross threads 946, for example, polypropylene thread, spaced along their length. Example hollow fibers may have an outer diameter of about 300 μm.

In FIG. 38, one such hollow fiber 942 may have, for example, an outer diameter of about 300 μm and an inner diameter of about 200 to 220 μm.

As shown in FIG. 39, the preferred hollow fiber 942 has slit-like micro pores 948 with, for example, an average pore size of 0.03 μm. Such hollow fibers may be polypropylene and made by an environmentally friendly dry stretch process.

FIG. 40 illustrates a preferred particular multiple contactor configuration or array in accordance with at least one embodiment of the present invention. This particular configuration is especially well suited for degassing water using modules or contactors and N₂ sweep gas and vacuum combination (Combo Mode). Although only three contactors are shown, it is understood that more or fewer contactors may be used. In accordance with a particular aspect of the present invention, this particular configuration is especially well suited for replacing or augmenting a conventional vacuum tower. For example, using multiple degassing modules or contactors (preferably with non-metallic housings) and N₂ sweep gas and vacuum in this particular configuration can easily produce degassed water.

FIGS. 43 and 44 show, respectively, counter-current and co-current applications of membrane contactors according to possibly preferred embodiments the present invention. In these figures, a first liquid goes in through inlet 1 and out through outlet 1, while a second liquid goes in through inlet 2 and out through outlet 2. These figures are representative of membrane contactors that may useful in ammonia removal and/or membrane (or osmotic) distillation.

FIG. 45 illustrates a preferred particular multiple contactor configuration or array in accordance with at least one particular embodiment of the present invention. This particular configuration is especially well suited for ammonia removal and/or membrane distillation. Although only three contactors are shown, it is understood that more or fewer contactors may be used.

Although the particular gas (or liquid) port or port seal design is not limited, the preferred is a gas (or liquid) port seal design that will work with both positive and negative pressures.

Some of the polymer components may be selected from, for example, polyvinyl chloride (PVC), chlorinated polyvinyl chloride (CPVC), high impact polystyrene (HIPS), polyacrylonitrile-butadi-ene-styrene (ABS), polyacrylate-styrene-acrlonitrile (ASA), and polycarbonate (PC).

In accordance with at least one example, the preferred materials for each of the major components may be as follows:

Module Housing: PVC, ABS, polyethylene, steel, stainless steel (SS), or any material that will bond with epoxy;

Center Tube: ABS, PVC, or the like;

Center Tube Connector: ABS, PVC, or the like;

Shell-Side End Port or Nozzle: Noryl™, ABS, Delrin (Acetal), steel, SS, or the like;

Lumen-Side End Port or Nozzle: 1″ threaded pipe (PVC, ABS, steel, SS, or the like);

End Cap: Delrin, PVC, ABS, CPVC, FRP, SS, Noryl™, steel, or the like;

Thread for hollow fiber array: PP or other polyolefin;

Hollow Fiber Polypropylene fiber (for example, Celgard® X-40 PP fiber or X-50 PP fiber) or some other fiber material that is inert to acids or other chemicals used during a process such as ammonia removal; hollow fiber material may also be selected based on having the appropriate/desired fiber strength, porosity and fiber wall thickness; and

Potting: Epoxy, thermoplastic, or the like.

In accordance with at least one possibly preferred example, the preferred materials for at least each of the major components are selected, optimized, constructed, connected, and/or adapted to operate in or for use in membrane distillation and/or ammonia removal methods, processes, systems, and/or arrays, and possibly more preferably for both membrane distillation and ammonia removal as well as other applications.

According to at least one inverted potting embodiment, the hollow fiber mats are embedded/potted in a resin by the following method: A staple of hollow fiber mats is introduced into a housing. In a first step, a plunger or plug is placed in one end of the housing and then fugitive or removable liquid or gel is introduced into the housing via the openings while the housing is spinning around its central axis. As a result, the fugitive or removable liquid or gel forms a layer into which the ends of the hollow fibers are embedded. In a second step a liquid hardenable resin is introduced into the housing and by the centrifugal effect forms a resin layer over the first layer of the fugitive or removable liquid or gel, such that the hollow fibers are embedded in the resin layer in a segment along the fiber length nearby the fiber ends. After hardening of the resin, the fugitive or removable liquid or gel and the plug are removed and the hollow fibers are embedded in the hardened resin such that the fibers extend with their ends beyond the resin layer. Then, the fiber ends are trimmed to form the recessed tube sheet with open ends of the fibers on the outer surface. This process is repeated for the other recessed tube sheet.

Potting or thermosetting materials may include, but are not limited to, epoxy, polyurethane, and thermoplastics. Epoxies are preferred. Thermoplastics, as used herein, refers to a high polymer that softens when exposed to heat and returns to its original condition when cooled to room temperature; the term is usually applied to synthetics such as polyvinyl chloride, nylons, fluorocarbon polymers, linear polyethylene, polyurethane prepolymer, polystyrene, polypropylene, and cellulosic and acrylic resins. Exemplary thermoplastics include polyolefins, such as polypropylene and polyethylene.

Different potting methods may be employed to form the potting or tube sheets. Such different potting methods include, but are not limited to, mold potting, centrifugal potting, and gravity potting.

In at least certain other embodiments, the present invention is directed to contactors, modules, systems, and/or methods of degassing liquids.

In at least particular possibly preferred embodiments, the contactor or module is integrally potted, has planar, disc shaped end caps, and a cylindrical housing or shell receiving and supporting a membrane structure. In at least particular possibly preferred embodiments, each of the planar disc shaped end caps has a central opening therein adapted to receive a liquid end port or nozzle, another opening therein adapted to receive a gas, or second liquid, end port or threaded pipe, and is held in place in the housing or shell by at least one retaining element such as a retaining or locking ring. In at least particular possibly preferred embodiments, the integrally potted membrane structure is potted in place in the housing or shell by an inverted potting process involving the use of a removable plunger or plug to recess the potting.

The instant application relates to membrane contactors or modules and their methods of manufacture and use. In at least selected embodiments, the present invention is directed to membrane contactors or modules and/or their methods of manufacture and/or use. In at least certain embodiments, the present invention is directed to contactors, modules, systems, and/or methods of effecting ammonia removal or membrane distillation with one or more hollow fiber membrane contactors or modules. In at least particular possibly preferred embodiments, the contactor or module is integrally potted, has planar, disc shaped end caps, and a high pressure cylindrical housing or shell receiving and supporting a membrane element or structure including a perforated core, a plurality of hollow fiber membranes, a tube sheet or potting affixing each end of the hollow fibers and adhering to the interior of the housing or shell. In at least particular possibly preferred embodiments, each of the planar disc shaped end caps has a central opening therein adapted to receive a liquid end port or nozzle, another opening therein adapted to receive a gas, or second liquid, end port or nozzle, and is adapted to be held in place in the cylindrical housing or shell by at least one retaining element such as a retaining or locking ring received in a groove in the interior of the cylindrical housing or shell. In at least particular possibly preferred embodiments, the integrally potted membrane structure is potted in place in the housing or shell by an inverted potting process involving the use of a removable plunger or plug to provide recessed potting and by trimming the end of the potting and opening the ends of the hollow fibers preferably using an internal lathe means (which can preferably reach into the housing to trim the recessed potting or tube sheet), and may also include machining or forming a larger diameter section for receiving the end cap, a groove for receiving the retaining ring, and a flared entrance for facilitating the insertion of the end cap and retaining ring preferably using an internal lathe means.

In at least particular possibly preferred embodiments, the contactor housing, shell, casing, or body is selected from standard PVC, CPVC, ABS, polypropylene, steel, or stainless steel pipe (preferably a pipe material that will bond with epoxy to facilitate integral potting), such as 1″ to 24″ (nominal pipe size)(nominal diameter) standard PVC, ABS, steel, or stainless steel pipe, preferably 2″ to 24″ (nominal pipe size) Schedule 80 PVC pipe or 2″ to 24″ (nominal pipe size) Schedule 40 PVC pipe, more preferably 4″ to 20″ (nominal pipe size) Schedule 80 gray PVC pipe, and most preferably 6″ to 18″ (nominal pipe size) Schedule 80 gray PVC pipe.

At least certain prior membrane cartridges were formed or machined to have tube sheets or hollow fibers which ended flush with the end of the cartridge. In contrast, at least selected possibly preferred embodiments of the present invention have potting, tube sheets and/or hollow fibers which end deeply recessed in the module housing (for example, a recess of at least 1″, preferably at least 2″, and more preferably 3″ or more in for example an 8″ nominal diameter Schedule 80 PVC pipe or housing). In accordance with at least selected possibly preferred embodiments, the deeply recessed potting, tube sheets and/or hollow fibers are trimmed or cut using an internal trimming or cutting means such as an internal lathe that can reach up into the housing (for example, a recess of at least 1″, preferably at least 2″, and more preferably 3″ or more in for example an 8″ nominal diameter Schedule 80 PVC pipe as the housing). In accordance with at least one possibly preferred embodiment of the present invention, the potting, tube sheets, and/or hollow fibers are deeply recessed in the housing by numerically controlled (NC) lathe machining such as lathe finish cutting with tapered blades.

In accordance with at least selected particular possibly preferred embodiments of the present invention, the housing is a machined or modified 1″ to 24″ (nominal pipe size)(nominal diameter) standard PVC, ABS, steel, or stainless steel pipe, preferably 2″ to 24″ (nominal pipe size) Schedule 80 PVC pipe or 2″ to 24″ (nominal pipe size) Schedule 40 PVC pipe, more preferably 4″ to 20″ (nominal pipe size) Schedule 80 gray PVC pipe, still more preferably 6″ to 18″ (nominal pipe size) Schedule 80 gray PVC pipe, and most preferably an about 8″ nominal pipe size Schedule 80 PVC pipe, the membrane is preferably integrally potted in the housing an inverted potting technique so the potting is recessed in the housing, the potting is preferably machined deeply recessed in the housing by, for example, numerically controlled (NC) lathe machining (preferably with no initial rough cut or additional finish cut operation), the contactor or module length is preferably easily shortened or extended by selecting shorter or longer housing lengths (for example with an 8″ nominal diameter Schedule 80 PVC pipe as the housing, the housing length may be selected to be about 10″ to 60″, preferably about 20″ to 50″, more preferably about 24″ to 36″), the end caps are preferably planar, disc shaped end caps or plates that fit inside the housing, and/or the end caps are preferably pressed into place and held in position with retaining rings (no bolts or v-band clamps needed) and may be press installed with an Arbor Press.

In accordance with at least selected embodiments of the present invention, it is preferred that the contactor operate, for example, at shell-side liquid pressures of about 5 to 200 psig, preferably 10 to 100 psig, more preferably 10 to 90 psig, and most preferably 10 to 60 psig, and at lumen-side gas vacuum or pressures of minus 14.7 psig to about positive 60 psig, preferably minus 14.7 psig to positive 30 psig, more preferably minus 10 psig to positive 15 psig, most preferably at about a minus 5 psig (to clarify terminology: psi=pounds per square inch, psig=pounds per square inch gauge, psia=pounds per square inch absolute, psig=psia+14.7 psi, 14.7 psia=normal atmospheric pressure, −14.7 psig=0 psia=lowest possible negative pressure or absolute vacuum).

In at least selected embodiments, the present invention is directed to high pressure membrane contactors and/or their methods of manufacture and/or use. In at least certain embodiments, the present invention is directed to effecting ammonia removal or membrane distillation with a hollow fiber membrane contactor. Preferably, the contactor has a high pressure housing, casing or shell enclosing at least one membrane element or structure, preferably an integrally potted shell side liquid, baffled membrane element, including a perforated core, a plurality of hollow fiber membranes, a tube sheet affixing each end of the hollow fibers to the cylindrical housing, shell or casing. More preferably, lumens of the hollow fibers are in fluid communication with a liquid, a sweep gas (a strip gas), a vacuum, or both, and the liquid from which ammonia is to be removed, for example, enters the contactor via an open end of the perforated core and radially exits through the core perforations, crosses over the exterior of the hollow fibers (the shell side or shell-side), optionally passes over at least one baffle and crosses over the exterior of another portion of the hollow fibers, returns to the core through the perforations, and exits the contactor with less dissolved or entrained gas, or less ammonia. The entrained or dissolved gas diffuses or passes from the liquid across the hollow fiber membrane and into the lumen Similarly, the ammonia in the shell-side liquid diffuses or passes from the liquid across the hollow fiber membrane and into the lumen, through which a solution of an acid (for example, sulfuric acid) has been flowing to effect the ammonia removal.

In at least selected embodiments, the present invention is directed to high pressure membrane contactors having high pressure housings or shells that are preferably selected from desired lengths of standard PVC, ABS, polypropylene, steel, or stainless steel pipe (preferably a pipe material that will bond with epoxy to facilitate integral potting), such as 1″ to 24″ (nominal pipe size)(nominal diameter) standard PVC, ABS, steel, or stainless steel pipe, preferably 2″ to 24″ (nominal pipe size) Schedule 80 PVC pipe or 2″ to 24″ (nominal pipe size) Schedule 40 PVC pipe, more preferably 4″ to 20″ (nominal pipe size) Schedule 80 gray PVC pipe, and most preferably 6″ to 18″ (nominal pipe size) Schedule 80 gray PVC pipe. Such pipe section housings are preferably machined or modified to receive end caps and retaining rings. The end caps may include both liquid and gas (or permeate) end ports or nozzles with the liquid ports or nozzles preferably adapted to operate under pressure and the permeate or gas ports preferably adapted to function under vacuum or reduced pressure conditions. In certain preferred embodiments, the end caps may include multiple liquid end ports or nozzles.

In at least selected embodiments, the present invention is directed to improved, unique and/or low cost ammonia removal and/or membrane distillation membrane contactors, modules or systems, their methods of manufacture, and/or methods of use thereof. In at least certain embodiments, the present invention is directed to membrane treatment of fluids such as ammonia removal or membrane distillation, using a membrane contactor or module. Preferably, the contactor has a pressure housing enclosing at least one membrane structure, element, cartridge, or unit preferably including a perforated core, a plurality of hollow fiber membranes, a tube sheet affixing each end of said hollow fibers, and an optional baffle. The membrane structure may be a shell side structure in which the hollow fiber lumens are in fluid communication with a an acid solution (in the case of ammonia removal), and the liquid from which ammonia is to be removed enters the contactor via an open end of the perforated core, radially exits the core perforations, crosses over the exterior (lumen-side) of the membranes within the housing, and exits the contactor with less ammonia. The ammonia preferably diffuses from the liquid across the microporous membrane into the lumen.

In at least one embodiment, a possibly preferred membrane structure is integrally potted and includes a perforated center tube, a membrane mat comprising a plurality of one or more types of hollow fiber membranes each having a first end and a second end both being open, an optional baffle separating the hollow fiber mat into two areas, and potting at each end. The first and second membrane ends are open, for example, to allow a lumen-side fluid to pass therethrough. It may be preferred that the baffle is formed of a center tube plug of a one piece center tube or of at least one connector joining at least first and second sections of a multi-piece center tube and by epoxy that is applied over the center tube connector in the mat or bundle, preferably the center of the mat or bundle, while winding thereby forming a dam or block through at least a portion, preferably substantially the entire thickness, of the hollow fiber mat. It may also be preferred that the potting be made of epoxy and that the ends of the potting be cut off to form the open first and second ends (tube sheets) following potting.

In accordance with at least one embodiment, the center tube forms an axial opening in each end of the membrane structure and is perforated along its length to provide radial openings for liquid to flow out through the perforations and over the hollow fibers. The axial opening in each end of the membrane structure is adapted to be in fluid communication with the liquid ports or nozzles in the end caps of the module. For example, a respective elongate nozzle may be used to connect the corresponding axial opening with the liquid supply.

In accordance with one possibly preferred aspect of the present invention, there is provided a commercially viable ammonia removal or membrane distillation contactor having a cylindrical housing or shell and at least one integrally potted membrane structure therein.

In accordance with another possibly preferred aspect of the present invention, there is provided a commercially viable contactor having a housing made of a length or section of modified standard pipe adapted to receive an end cap in each end thereof.

In accordance with yet another possibly preferred aspect of the present invention, there is provided a commercially viable membrane contactor for ammonia removal and/or membrane distillation having an integrally potted membrane structure with deeply recessed tube sheets in a cylindrical housing or shell.

In accordance with still yet another possibly preferred aspect of the present invention, it was discovered that a commercially viable, high pressure membrane contactor for ammonia removal and/or membrane distillation could be constructed using a desired length of standard PVC, ABS, steel, or stainless steel pipe modified to receive and retain end caps therein.

Membrane contactors of the present invention may make it possible to transfer gas to or from an aqueous stream (or remove ammonia from a liquid stream) without dispersion. Such membrane contactors may contain thousands of Celgard® microporous polyolefin, for example, hydrophobic polypropylene, hollow fibers knitted into an array using polypropylene thread (see FIG. 37) that is wound around a distribution tube and collection tube (respective portions of a perforated center tube). The hollow fibers are preferably arranged in a uniform open packing, allowing greater flow capacity and utilization of the total membrane surface area. Because the hollow fiber membrane is preferably hydrophobic, the aqueous stream will not penetrate the pores. The gas/liquid interface is immobilized at the pore by applying a higher pressure to the aqueous stream relative to the gas stream. Unlike dispersed-phase contactors such as packed columns, the present possibly preferred membrane contactors provide a constant interfacial area for transfer over the entire operating range of flow rates.

The possibly preferred membrane contactors of the present invention may include a bundle of microporous hollow fibers, a rigid shell or housing enclosing the fiber bundle, and an end cap at each end of the housing. The end caps may be provided with four fluid ports: an inlet for introducing the first fluid, an outlet for discharging the first fluid, an inlet for introducing the second fluid, and an outlet for discharging the second fluid. The hollow fibers may be potted on both ends, recessed within the housing, to form polymeric tube sheets with the fiber bores opening on each end into common first and second end cap portions of the contactor. Although not preferred, in a “tube-side” or “lumen-side” type contactor, the first end cap may contain the inlet for the first fluid, which is designated the “tube-side” or “lumen-side” fluid because it is the fluid that passes through the internal lumens of the fibers. The second end cap contains the outlet for discharging the lumen-side fluid. The second fluid, designated the “shell-side” fluid, typically enters and exits the housing through inlet and outlet ports arranged between the tube sheets, whereby the shell-side fluid contacts the external surfaces of the fibers. The shell-side fluid flows through the interstices between fibers of the fiber bundle, and may be directed to flow parallel or perpendicular to the fiber length.

In the preferred “shell-side” contactor, the contactor may include a central core which passes through the membrane structure and has a first end serving as the inlet for the first fluid, which is designated the “shell-side” fluid because it is the fluid that passes over the exterior or shell of the hollow fibers. The first end cap may contain the inlet or port for the second fluid, which is designated the “tube-side” or “lumen-side” fluid because it is the fluid that passes through the internal lumens of the fibers. The second end cap contains the outlet for discharging the lumen-side fluid. The first fluid, designated the “shell-side” fluid, may enter and exit the end caps via respective inlet and outlet ports or nozzles operatively connected to the open ends of the perforated core, and typically exits and re-enters the perforations in the core between the tube sheets whereby the shell-side fluid contacts the external surfaces of the fibers. The shell-side fluid flows through the interstices between fibers of the fiber bundle, and may be directed to flow parallel and/or perpendicular to the fiber length.

Because the tube sheets separate the lumen-side fluid from the shell-side fluid, the lumen-side fluid does not mix with the shell-side fluid, and typically the only transfer between the lumen-side fluid and the shell-side fluid occurs through the walls of the hollow fibers. The fine pores in the fiber wall are normally filled with a stationary layer of one of the two fluids, the other fluid being excluded from the pores due to surface tension and/or pressure differential effects. Mass transfer and separation are usually caused by diffusion, which is driven by the difference in concentration of the transferring species between the two phases. Typically, no convective or bulk flow occurs across the membrane.

The hollow fibers are preferably made of polyolefin materials such as polypropylene and may also be made of polymethyl pentene (PMP, or poly(4-methyl-1-pentene)), polyvinylidene fluoride (PVDF), microporous hydrophobic PVDF, copolymers of polyvinylidene fluoride, such as a copolymer of polyvinylidene fluoride and hexafluoropropylene (PVDF:HFP), other polyolefins (e.g., polyethylene, polybutene), polysulfones (e.g., polysulfone, polyethersulfone, polyarylsulfone), cellulose and its derivations, poly phenyl oxide (PPO), PFAA, PTFE, other fluorinated polymers, polyamides, polyether imides (PEI), polyimides, polyamideimides (PAI), combinations, blends or copolymers thereof, and/or the like.

Although the possibly preferred present membrane contactors utilize a microporous membrane, the separation principle differs substantially from other membrane separations such as filtration and gas separation. With such preferred hollow fiber membrane contactors, there is no convective flow through the pores as occurs in other membrane separations. Instead, the preferred membrane acts as an inert support that brings the liquid and gas phases in direct contact without dispersion. The mass transfer between the two phases is governed entirely by the pressure of the gas phase. Because of the preferred Celgard® hollow fibers and the contactor geometry, the surface area per unit volume is an order of magnitude higher than traditional technologies such as packed columns, forced draft deaerators and vacuum towers. This high level of surface area to volume leads to a dramatic reduction in contactor/system size for a given level of performance.

It is noted that although the baffled membrane design appears to be preferred, there appear to be three design variants for the presently described membrane contactors. The baffled membrane design uses a radial liquid flow path around a central baffle. Liquid flows on the outside (shell side or shell-side) of the hollow fibers. The NB, or No Baffle design, does not utilize a central baffle, but it is still a radial flow device. The liquid outlet port on the no baffle design is located in the middle of the device rather than at the contactor ends as in the baffled design. One end of the NB contactor is capped and allows liquid to flow outward or radially across the fibers from a central distribution tube. This variant appears best suited for vacuum operation. The third variant or design allows for liquid flow inside of the hollow fiber (lumen side or lumen-side). These devices are not radial flow devices and appear best suited for small flow applications.

The present possibly preferred membrane contactors may utilize one of several fiber types, such as PP, PMP, or PVDF, which may be well suited for absorption/stripping techniques for water. PVDF fibers may better handle sanitizers added to seawater. The Celgard® X-40 membrane has a thicker wall with a smaller inside diameter than the X-50 and is recommended for oxygen removal. The Celgard® X-50 membrane has a slightly thinner wall with a larger inside diameter. (see FIGS. 38 and 39) This feature allows for greater carbon dioxide removal as compared to the X-40 membrane.

Below is a comparison of the Celgard® X-40 and X-50 hollow fibers.

TABLE 1
Celgard ® X-40 and X-50
Hollow Fiber Comparison

| | | Fiber Type | |
|---|---|---|---|
| Characteristic | Units | X-40 | X-50 |
| Fiber OD (nominal) | Microns | 300 | 300 |
| Fiber ID (nominal) | Microns | 200 | 220 |
| Bubble Point | psi | 240 | 240 |
| Load at Break | grams | 430 | 430 |
| Porosity | % | 25 | 40 |
| Average Pore Size | Microns | 0.03 | 0.04 |

A possible third fiber variant, a microporous polyolefin, was introduced in smaller contactors for gas transfer of low surface tension fluids and the fluid always flows on the shell side in these devices. Furthermore, a microporous PVDF fiber has been introduced for better tolerance of oxidizing species in water. Additionally, an XIND fiber was introduced in larger industrial contactors, and is geared to non-FDA degassing applications.

When using the Baffled or No-Baffle Membrane Contactors in gas absorption applications such as aeration or carbonation, etc., a gas is introduced into the inside (lumen side) of the hollow fiber membrane and the liquid phase is introduced to the outside (shell side) of the hollow fiber. The partial pressure of the gas and the water temperature controls the amount of gas dissolved in the liquid phase. When using Lumen Side Liquid membrane contactors (non radial flow devices) in this application, the liquid is introduced to the lumen side while the gas is introduced to the shell side.

When using the Baffled or No Baffle Membrane Contactors in gas stripping applications such as decarbonation or deoxygenation, a vacuum or stripping gas or combination of those is applied to the lumen side of the hollow fiber. The liquid stream is introduced to the outside of the fiber. The partial pressure of the gas is decreased to remove dissolved gases from the liquid phase. When using Lumen Side Liquid membrane contactors (non radial flow devices) in this application, the liquid is introduced to the lumen side while the gas/vacuum is applied to the shell side.

In another embodiment, a spiral-type hollow fiber membrane fabric-containing module or contactor for membrane distillation or ammonia removal may have an 8×20 configuration (or other sized similar configurations) with a module housing made of a modified section of pipe having an 8 inch diameter and a 20 inch length. This embodiment of a spiral-type hollow fiber membrane fabric-containing module may include a pair of end caps that may be adapted to fit in the ends of the module housing. Liquid end ports may be in each of the end caps. At least one gas port may be in at least one of the end caps or in the side of the module housing near one end thereof. At least one membrane structure may be adapted to fit in the module housing. Each membrane structure may include:
a. a plurality of hollow fiber membranes each having a lumen, said membranes being formed into a fabric-like array in which the hollow fibers substantially are mutually-parallel and constitute the fabric weft, and are held in spaced-apart relationship by filaments constituting the fabric warp;
b. the array being wound upon an axis which is substantially parallel to the hollow fibers into a spirally-wound membrane bundle having two bundle ends and a cylindrical exterior surface;
c. each of the two bundle ends being potted in resinous potting material serving to seal the bundle end into an adjacent monolithic tube sheet, a portion of the bundle between the two tube sheets being free from potting material to form a shell-side region, and the lumen ends of the hollow fibers constituting a first one of the bundle ends being exposed and communicating with the exterior of the bundle;
d. the module shell, casing or housing having first and second housing ends and a cylindrical housing interior and being suitably shaped to contain the membrane bundle, the tube sheet (potting) recessed relative to the first housing end sealing the first bundle end to the cylindrical housing interior, said module housing which contains the bundle defining two regions mutually communicating through the membrane including (i) a shell-side space exterior to the portion of the bundle between the tube sheets and within the housing, and (ii) a lumen-side space including the hollow fiber lumens and the first bundle end;
   An interior face of a first of the end caps and an interior of the module housing adjacent the first tube sheet, together with the cylindrical housing interior and the first bundle end, may seal a first module housing end and define a first chamber communicating with the membrane lumens. An interior face of a second of the end caps and an interior of the module housing adjacent a second tube sheet recessed from the second housing end, together with the cylindrical housing interior and a second bundle end, may seal a second module housing end and define a second chamber communicating with the membrane lumens. The liquid end ports may be operatively connected to the shell-side space of the membrane structure, and may be arranged to permit fluid injection and withdrawal there through. The at least one gas port may communicate with at least one of the first and second chambers, and may be arranged to permit gas injection and withdrawal there through. At least two gas ports, with one gas port the end caps or in each side of the module housing near each end thereof. A hollow mandrel may be in each of the membrane structures having a longitudinal axis and a cylindrical exterior surface, an axial bore, and perforations along the surface which communicate with the bore. Both of the lumen ends of the hollow fibers may be exposed and may communicate with the exterior of the bundle. The module housing may be a section or length of standard pipe modified to receive and retain the end caps. The module housing and end caps may contain and restrain the membrane structure should it fail.

The above embodiment of a spiral-type hollow fiber membrane fabric-containing module or contactor may be used for membrane distillation and/or ammonia removal, or multiple membrane contactors, may be used for membrane distillation and/or ammonia removal. The above embodiment of a spiral-type hollow fiber membrane fabric-containing module or contactor may be preferred for membrane distillation and/or ammonia removal, or multiple membrane contactors, may also be preferred for membrane distillation and/or ammonia removal.

In another embodiment, an integrally potted hollow fiber membrane contactor for membrane distillation or ammonia removal may have an 8×20 configuration (or other sized similar configurations) with a high pressure cylindrical housing having an 8 inch diameter and a 20 inch length. This embodiment of an integrally potted membrane contactor may include planar, disc shaped end caps, domed shaped end caps and/or other molded shaped end caps. The high pressure cylindrical housing may receiving and support a membrane element including a perforated core, a plurality of hollow fiber membranes, a tube sheet affixing each end of the hollow fibers and adhering to the interior of the housing. Each of the end caps may have a central opening therein that may be adapted to receive a liquid end port, another opening therein that may be adapted to receive a gas end port, and may be adapted to be held in place in the cylindrical housing by at least one retaining element which may be a retaining ring received in a groove in the interior of the cylindrical housing. The integrally potted membrane structure may be potted in place in the housing by an inverted potting process involving the use of a removable plunger to provide recessed potting and by trimming the end of the potting and opening the ends of the hollow fibers using an internal lathe means. Opening the ends of the hollow fibers means exposing the fiber lumens and thereby providing access to the insides of the hollow fibers for the lumen-side fluid. The housing may include a larger diameter section for receiving the end cap, the groove for receiving the retaining ring, and a flared entrance for facilitating the insertion of the end cap and retaining ring.

In an ammonia removal system, for example, the fluid comprising ammonia may be the shell-side fluid, which may be inserted into a port or inlet in an end cap of a membrane contactor. Such a shell-side fluid may flow, for example, through the inlet into the core of the membrane contactor, which core may be perforated with a plurality of holes. The holes or perforations in the core allow the fluid to flow out of the core into the membrane structure comprising hollow fibers and allow the fluid to encounter the shell-sides of the hollow fibers in the membrane structure. In some embodiments, the inlet for the shell-side fluid may be substantially in the center of an end cap of the membrane contactor.

In certain embodiments, a counter-flow of a fluid containing one or more acids may be used to effect ammonia removal from a shell-side fluid containing ammonia. For example, the counter-flow fluid may be a solution of sulfuric acid. Further, this counter-flow fluid may be the lumen-side fluid. Such a lumen-side fluid may be inserted into an inlet port in an end cap of a membrane contactor. In certain embodiments, the inlet port for the lumen-side fluid, for example, a fluid containing one or more acids, may be located offset from the center of the end cap. In certain embodiments, the lumen-side fluid (for example, a fluid comprising acid) encounters the lumens of the hollow fibers by flowing through the inlet port in an end cap of the contactor and by moving inside the lumens of the hollow fibers, which lumens were exposed when the potted hollow fibers were cut open during manufacture of the membrane contactor.

While not wishing to be bound by theory, it is believed that the respective surface tensions of the two fluids (the shell-side fluid and the lumen-side fluid) come into play and allow for ammonia removal to take place in an ammonia removal application (or a chemisorption application). The pores, for example, micropores, in the walls of the hollow fibers in the membrane structure allow for the chemical reaction of the ammonia removal process to take place.

The above embodiment of an integrally potted hollow fiber membrane contactor, or multiple membrane contactors, may be used for membrane distillation. The above embodiment of an integrally potted hollow fiber membrane contactor, or multiple membrane contactors, may also be used for ammonia removal.

In one embodiment of the instant invention, a system for membrane (or osmotic) distillation or ammonia removal may be provided. The system may include at least one hollow fiber membrane module or contactor for membrane distillation or ammonia removal, according to any one of the embodiments described above. In one embodiment of the system, at least two hollow fiber membrane modules or contactors for membrane distillation or ammonia removal according to any one of the embodiments described above may be included.

The instant invention also contemplates a method of membrane distillation comprising the step of using the membrane contactor for membrane distillation or ammonia removal according to any one of the embodiments described above.

The instant invention also contemplates a method of ammonia removal comprising the step of using the membrane contactor for membrane distillation or ammonia removal according to any one of the embodiments described above.

Background information for at least certain TMCS (Trans-Membrane Chemi-Sorption) for the ammonia removal process in accordance with at least selected particular embodiments:
Plant ‘waste’ water with generally 100 to 2000 mg/L of dissolved ammonia, sometimes even higher.
Wastewater temperature is ambient, which is normally around 30 C.
Sodium or Potassium Hydroxide injected in-line to wastewater to raise pH to 11.0 or higher to ‘release’ ammonia from chemically bound form to free dissolved gas form.
Wastewater flows on shell side of contactor, single pass.
An acid solution, typically 5% Sulfuric Acid, flows on lumen side of contactor in recirculation mode, supplied from an acid holding tank.
Ammonia in gaseous form transfers from wastewater to acid phase across the hollow fiber wall.
Acid reacts with ammonia to generate ammonium sulfate salt, concentration of which increases with time.
As acid is consumed in reaction, fresh acid (typically in 50%-98% concentration) is added to the acid holding tank to replenish; so acid tank has a mixture of acid and ammonium sulfate in water at any time.
Addition of acid to acid tank generates heat and raises acid solution temperature; reaction of ammonia and acid also generates heat.
Process continues until ammonium sulfate concentration in acid tank reaches a maximum, at which point acid supply is switched to a second holding tank, while the content of the first holding tank is processed for disposal.

In general, in accordance with at least certain embodiments, the ammonia removal or TMCS process has two chemical reactions going on: On feed side, any ammonium ion converts to gas form by adding NaOH (source of OH⁻)

NH₄⁺+OH⁻→NH₃(gas)+H2O

On lumen side, the NH₃ gas reacts with Sulfuric Acid and converts to Ammonium Sulfate form

2NH₃(gas)+H2SO4→(NH₄)₂SO₄

Membrane technology is an alternative for ammonia removal and recovery from wastewater compared to many other water treatment processes, such as strippers, scrubbers, and deaeration systems. Among the available alternatives, the TransMembraneChemiSorption (TMCS) may be preferred under under certain operating conditions.

The TransMembraneChemiSorption (TMCS) separation technique preferably uses a membrane device to strip a gas species from a liquid feed phase and captures it using a liquid receiving phase that chemically reacts with the gas species. The hydrophobic hollow fiber membrane can be used as a medium to separate aqueous phases because it is not inherently selective between permeating species. The driving force for mass transfer of the species through the microporous hollow fiber membrane is the difference in concentrations between the two phases. Mass transfer stops when chemical equilibrium is reached. In the TMCS process, the driving force remains high because the transferred component chemically reacts in the receiving phase, allowing concentration levels in the receiving phase to remain at or near zero. In order to remove ammonia from a wastewater stream by TMCS, the dissolved ammonium ions (NH4+) are converted to free ammonia gas (NH3). At normal water temperatures, this is accomplished by dosing the water with an alkali to raise the pH to a sufficiently high level. The wastewater, containing a high concentration of free ammonia gas, is led into a Liqui-Cel® extra-flow membrane contactor and introduced to the outside (shellside) of the hollow fibers. A counter-current flow of an acid solution is introduced to the inside of the hollow fibers (lumenside). Due to the difference in ammonia gas concentration between the wastewater stream and acid solution, the NH3 gas transfers across the microporous membrane. In the receiving phase, the NH3 instantly reacts with the acid. This reaction forms an ammonium salt and is virtually irreversible. In theory, all free ammonia can be removed from a wastewater stream in a single step provided there are enough H+ ions available in the receiving phase and there is sufficient contact time for the chemisorption process to occur. In reality, the rate of ammonia transfer is limited by the maximum flow rate the membrane module can handle and the concentration gradient from inlet to outlet of the module. Connecting the membrane contactors in parallel or in series is essential for optimal system performance, size and cost. Water vapor transport between the feed phase and the receiving phase may also be considered because it can reduce the driving force and decrease system performance.

The applicability of a TMCS system may depend on the operating conditions and the goal of the separation process. The standard water quality requirements for at least certain contactors or modules are 5-10 lm pre-filtration and a low fouling index. The membrane contactor materials may show good resistivity against high or low pH. For operating temperatures up to 50° C., the pressure on the shellside and lumenside of the hollow fiber may be limited to about 3 bar.

The objective of a TMCS process is to remove as much NH3 from the wastewater as possible at minimal cost and risk while recovering some value to generate a quicker return. The cost-benefit analysis may involve capital expenses, operating expenses, cost savings, and the value of the resulting end products.

In accordance with at least selected Membrane (or Osmotic) Distillation embodiments:

The inventive membrane contactors are preferably used in a type of Membrane Distillation (MD) called Direct Contact Membrane Distillation (DCMD). There are other types of MD including Air Gap MD (AGMD), Vacuum MD (VMD), and others. Generally, for DCMD we flow a hot water (usually salt water) stream on one side of the membrane and a cold water directly on the other side of the membrane. The porosity of the membrane acts as an air gap between the two streams. Water does not enter the pore structure due to the hydrophobic behavior of the membrane. The hot (salt) water will have a higher vapor pressure than the cold (distilled) water. This vapor pressure differential is the driving force that causes the hot water source to evaporate across the membrane and condense on the cold water side.

The process of evaporation and condensation will cause a temperature change from the hot to the cold due to the heat of vaporization or the latent heat. There is also a temperature change between the hot and the cold due to convection between the two streams. The latter temperature change should be minimized as much as possible, since this temperature change may not do any useful work as far as the MD process is concerned and may lower the driving force between the two streams. This effect can be minimized by selecting membranes that have low coefficients of conduction. In other words they have insulating properties between the hot and cold streams.

In accordance with at least particular embodiments, it is important to select a membrane that offers good vapor transport properties (no restrictions) and that is somewhat insulating between the hot and cold water streams. The fiber is preferably also hydrophobic and has a pore size distribution that prevents any water breakthrough across the membrane. The MD process may be operating pressure independent, but the pore size should be small enough to prevent water pressure from breaking through the fiber wall. As an example a fiber with good properties would be PP or PVDF, having an inside diameter of 315 micron, an outside diameter of 600 micron, a porosity of 70%, and a nominal pore size of <0.2 micron.

In accordance with at least selected embodiments, aspects or objects, the present disclosure or invention relates generally to new, improved, or modified membrane contactors, modules, systems, and/or methods for membrane distillation and/or ammonia removal, and/or methods of manufacture, use, and/or the like. In accordance with at least certain selected embodiments, the present invention relates to particular possibly preferred membrane contactors, modules, systems, and/or methods for membrane distillation and/or ammonia removal, and/or to particular possibly preferred membrane contactors, modules, systems, and/or methods for membrane distillation and/or ammonia removal, involving membrane contactors adapted for membrane distillation, for ammonia removal, or for both membrane distillation and for ammonia removal, as well as other membrane contactor systems, methods or processes such as degassing, gasifying, separation, filtration, and/or the like. In accordance with at least one particular embodiment, the same particular membrane contactor may be used for membrane distillation and for ammonia removal, and is adapted to operate in both membrane distillation and ammonia removal arrays, systems, methods or processes.

The present invention may be embodied in other forms without departing from the spirit and the essential attributes thereof, and, accordingly, reference should be made to the appended claims, rather than to the foregoing specification, as indicated in the scope of the invention.

We claim:

1. A membrane contactor for at least one of membrane distillation and ammonia removal.

2. The membrane contactor of claim 1 wherein the contactor is adapted for use in both membrane distillation and ammonia removal

3. The membrane contactor of claim 1 comprising a cylindrical housing or shell made of a length of modified pipe, and wherein said cylindrical housing having:
a diameter between 4-16 inches; and
a length between 6-40 inches.

4. The membrane contactor of claim 3 having an 8×20 configuration comprising:
said cylindrical housing having an 8 inch diameter and a 20 inch length.

5. The membrane contactor of claim 3 further comprising:
at least one integrally potted hollow fiber membrane structure in said cylindrical housing with the ends of said membrane structure recessed in said housing a recess of at least 1″ from each end, and
respective disc shaped, domed shaped, other molded shapes, or combination thereof end caps adapted to be received in each open end of said housing.

6. The membrane contactor of claim 5, wherein said membrane structure is recessed in said housing a recess of at least 2″ from each end.

7. The membrane contactor of claim 5, wherein said end caps each having at least one of liquid and gas ports therein and adapted to be held in place in said cylindrical housing by at least one retaining element being a retaining or locking ring received in a groove in the interior of said cylindrical housing.

8. The membrane contactor of claim 5, wherein said end caps each having a central opening therein adapted to receive a liquid end port or nozzle, and another opening therein adapted to receive a gas end port or pipe.

9. The membrane contactor of claim 5, wherein said integrally potted membrane structure including a perforated core, a plurality of hollow fiber membranes, a tube sheet or potting affixing each end of the hollow fibers and adhering to the interior of said housing.

10. The membrane contactor of claim 5, wherein said integrally potted membrane structure being potted in place in said housing by an inverted potting process involving the use of a removable plunger or plug and trimming the ends of the potting and opening the ends of the hollow fibers using a cutting means to produce recessed tube sheets.

11. The membrane contactor of claim 3, wherein said length of pipe of said cylindrical housing is formed of a modified section of pipe including in each end a larger diameter section for receiving an end cap, a groove for receiving a retaining ring, and a flared entrance for facilitating the insertion of the end cap and retaining ring.

12. The membrane contactor of claim 11, wherein said length of pipe is selected from standard PVC, ABS, polypropylene, steel, stainless steel, or other pipe material that will bond with epoxy to facilitate integral potting.

13. The membrane contactor of claim 1 being used for membrane distillation.

14. The membrane contactor of claim 1 being used for ammonia removal.

15. The membrane contactor of claim 1 being a spiral-type hollow fiber membrane fabric-containing module or contactor adapted for membrane distillation or ammonia removal.

16. The module or contactor of claim 15 having an 8×20 configuration comprising:
a module housing made of a modified section of pipe;
said module housing having an 8 inch diameter and a 20 inch length.

17. The module or contactor of claim 16 further comprising:
a pair of end caps adapted to fit in the ends of said module housing;
liquid end ports in each of said end caps;
at least one gas port in at least one of said end caps or in the side of said module housing near one end thereof;
at least one membrane structure adapted to fit in said module housing, each membrane structure comprising:
a. a plurality of hollow fiber membranes each having a lumen, said membranes being formed into a fabric-like array in which the hollow fibers substantially are mutually-parallel and constitute the fabric weft, and are held in spaced-apart relationship by filaments constituting the fabric warp;
b. the array being wound upon an axis which is substantially parallel to the hollow fibers into a spirally-wound membrane bundle having two bundle ends and a cylindrical exterior surface;
c. each of the two bundle ends being potted in resinous potting material serving to seal the bundle end into an adjacent monolithic tube sheet, a portion of the bundle between the two tube sheets being free from potting material to form a shell-side region, and the lumen ends of the hollow fibers constituting a first one of the bundle ends being exposed and communicating with the exterior of the bundle;
d. the module shell, casing or housing having first and second housing ends and a cylindrical housing interior and being suitably shaped to contain the membrane bundle, the tube sheet (potting) recessed relative to the first housing end sealing the first bundle end to the cylindrical housing interior, said module housing which contains the bundle defining two regions mutually communicating through the membrane including (i) a shell-side space exterior to the portion of the bundle between the tube sheets and within the housing, and (ii) a lumen-side space including the hollow fiber lumens and the first bundle end;
wherein an interior face of a first of said end caps and an interior of said module housing adjacent the first tube sheet, together with the cylindrical housing interior and the first bundle end, seal a first module housing end and define a first chamber communicating with the membrane lumens;
wherein an interior face of a second of said end caps and an interior of said module housing adjacent a second tube sheet recessed from the second housing end, together with the cylindrical housing interior and a second bundle end, seal a second module housing end and define a second chamber communicating with the membrane lumens;
said liquid ends ports being operatively connected to the shell-side space of the membrane structure, and arranged to permit fluid injection and withdrawal there through; and
the at least one liquid or gas port communicating with at least one of the first and second chambers, and arranged to permit liquid entry or gas injection and exit or withdrawal there through.

18. The module or contactor of claim 17, further comprising:
at least two liquid or gas ports with one port in each of said end caps or in each side of said module housing near each end thereof.

19. The module or contactor of claim 15 being adapted for use for membrane distillation and ammonia removal.

20. A system for membrane distillation or ammonia removal comprising: at least one hollow fiber membrane module or contactor according to claim 1.

21. A system for membrane distillation or ammonia removal comprising: at least one hollow fiber membrane module or contactor according to claim 2.

22. The system for membrane distillation or ammonia removal of claim 20, comprising: at least two hollow fiber membrane modules or contactors.

23. The system for membrane distillation or ammonia removal of claim 21, comprising: at least two hollow fiber membrane modules or contactors.

24. A method of membrane distillation or of ammonia removal comprising the step of using the membrane contactor according to claim 1.

25. A method of membrane distillation or of ammonia removal comprising the step of using the membrane contactor according to claim 2.
